(19) United States
(12) Patent Application Publication
(10) Pub. No.: US 2026/0014488 A1
(43) Pub. Date: Jan. 15, 2026

(54) TOY VEHICLE BODY AND METHOD OF MANUFACTURING THE SAME

(71) Applicant: Mattel, Inc., El Segundo, CA (US)

(72) Inventors: Matthew Licea Polo, Redondo Beach, CA (US); Guo Hong Yuan, Shenzhen City (CN); Chi Hang Roger Wong, Hong Kong (HK); Wei Guo, Shenzhen City (CN)

(21) Appl. No.: 18/772,333

(22) Filed: Jul. 15, 2024

(51) Int. Cl. A63H 17/26; B32B 1/00; B32B 27/08; B32B 27/30; B32B 27/32

(52) U.S. Cl. CPC A63H 17/262; B32B 1/00; B32B 27/08; B32B 27/304; B32B 27/32; B32B 2250/02; B32B 2250/24; B32B 2255/10

(57) ABSTRACT

A toy vehicle body and a method of manufacturing the toy vehicle body address issues with conventional toy vehicle bodies. The toy vehicle body is a plastic shell, such as for a remote control vehicle. A paint is printed onto a film material, which in turn is laminated onto a second material to capture the printed paint between the film material and the second material. In one embodiment, the printed film material is a cast polypropylene film material, and the second material is a polyvinyl chloride sheet. The lamination process results in a laminated/multi-layered material that is used to form the toy vehicle shell or body.

### TECHNICAL FIELD

The present application relates generally to a toy vehicle and, in particular, to a toy vehicle that has a vacuum formed body or shell.

### BACKGROUND

Toys provide entertainment for different users, such as children. For example, a toy may include various features with which a child may play. An example toy that may entertain a child is a toy vehicle. In some conventional toy vehicles, paint is applied to the body of the toy vehicle to enhance the appearance of the toy vehicle, and in some instances, making the toy vehicle recognizable as a particular type of toy vehicle and/or decorating the toy vehicle.

In some conventional toy vehicles, paints are accessible to a child playing with the toy vehicle because the paints have been silk screen printed on the surface of a toy vehicle body. Such conventional toy vehicles may include a vacuum-formed remote control (“R/C”) toy vehicle body. In some vacuum-formed R/C toy vehicle bodies, it may be desirous to prevent the ability of the paint on the toy vehicle bodies from being scraped off during play with the toy vehicle.

Thus, there is a need for a toy vehicle body that contains paint that is not easily accessible and/or scraped off of a surface of the toy vehicle body.

### SUMMARY

A toy figure according to the aspects presented herein includes a frame having a plurality of wheels coupled thereto, and a body coupled to the frame, wherein the body includes a first layer of material on which another material is printed and a second layer of material, the second layer of material being coupled to the first layer of material, and the body is shaped into a three-dimensional shape.

In one embodiment, the body is shaped into the three-dimensional shape by vacuum forming.

In an alternative embodiment, the second layer of material is laminated to the first layer of material.

In another embodiment, the second layer of material is polyvinyl chloride.

In yet another embodiment, the first layer of material is a cast polypropylene film.

In one embodiment, the first layer of material has a first side and a second side opposite the first side, and the material printed on the first layer of material is printed on the first side of the first layer of material.

In another embodiment, the second layer of material is coupled to the first side of the first layer of material so that the material printed on the first side of the first layer of material is located between the first layer of material and the second layer of material.

In an alternative embodiment, the second layer of material is laminated to the first layer of material.

A shell for a body of a toy vehicle according to the aspects disclosed herein includes a first layer of material, a second layer of material, and a patterned material, wherein the patterned material is disposed on the first layer of material, the second layer of material is coupled to the first layer of material, and the first layer of material and the second layer of material are formed into a three-dimensional shape.

In one embodiment, the first layer of material and the second layer of material are formed into a three-dimensional shape by vacuum forming.

In another embodiment, the patterned material is printed onto the first layer of material.

In yet another embodiment, the patterned material is located between the first layer of material and the second layer of material when the second layer of material is coupled to the first layer of material.

In an alternative embodiment, the second layer of material is laminated to the first layer of material.

In another embodiment, the first layer of material is a cast polypropylene film and the second layer of material is polyvinyl chloride.

In an alternative embodiment, the first layer of material has a first side and a second side opposite the first side, and the patterned material is printed on the first side of the first layer of material.

In one embodiment, the second layer of material is coupled to the first side of the first layer of material so that the patterned material is located between the first layer of material and the second layer of material.

A method of manufacturing a body of a toy vehicle according to the aspects disclosed herein includes the steps of printing a pattern onto a first material, laminating a second material to the first material, the pattern being located between the second material and the first material, and forming the laminated first material and second material into a three-dimensional shape for use as the body of a toy vehicle.

In one embodiment, the first material is a cast polypropylene material, and the second material is a polyvinyl chloride material.

In another embodiment, the method includes the step of cutting the laminated first material and second material into single pieces prior to the step of forming the laminated first material and second material.

In an alternative embodiment, the method includes the step of trimming the three-dimensional shape after the step of forming the laminated first material and second material.

### BRIEF DESCRIPTION OF THE DRAWINGS

The toy vehicle and method of manufacturing the same presented herein may be better understood with reference to the following drawings and description. Unless dimensions of elements of the drawings are specifically called-out and described herein, it should be understood that the elements in the figures are not necessarily to scale and that emphasis has been placed upon illustrating the principles of the toy vehicle. In the drawings, like-referenced numerals designate corresponding parts throughout the different views.

FIG. 1 illustrates a front perspective view of a toy vehicle according to the present invention.

FIG. 2 illustrates an exploded partial perspective view showing different material layers according to the present invention.

FIG. 3 illustrates a top view of a patterned material disposed on a first material layer according to the present invention.

FIG. 4 illustrates a perspective view of an embodiment of a laminating system according to the present invention.

FIG. 5 illustrates a perspective view of multiple material layers that are laminated according to the present invention.

FIG. 6 illustrates a perspective view of the layers illustrated in FIG. 5 laminated together.

FIG. 7 illustrates a perspective view of the rolled continuous laminated layers.

FIG. 8 illustrates a perspective view of the continuous laminated layers moving from the rolled configuration illustrated in FIG. 7 to a cutting machine.

FIG. 9 illustrates a perspective view of single sheets of the laminated layers that are collected for further processing according to the present invention.

FIG. 10 illustrates a perspective view of a laminated sheet prior to being vacuum formed according to the present invention.

FIG. 11 illustrates a perspective view of a die that is used in the vacuum forming process.

FIG. 12 illustrates a perspective view of a body for a toy vehicle after the laminated sheet vacuum formed according to the present invention.

FIG. 13 illustrates a perspective view of the body illustrated in FIG. 12 being trimmed.

FIG. 14 illustrates a top perspective view of the trimmed body illustrated in FIG. 13.

FIG. 15 illustrates a perspective view of the trimmed body illustrated in FIG. 13.

FIG. 16 illustrates an exemplary method of manufacturing a toy vehicle body according to the present invention.

### DETAILED DESCRIPTION

In a toy vehicle according to the aspects disclosed herein, the issue of easily accessible and/or scraped off paint on the toy vehicle is addressed. In one implementation, a toy vehicle body and a method of manufacturing a toy vehicle body that addresses the issues with conventional toy vehicle bodies has been identified. The toy vehicle body is a plastic shell, such as for a remote controlled or radio-controlled (“R/C”) vehicle. A paint is printed onto a film material, which in turn is laminated onto a second material to capture the printed paint between the film material and the second material. In one embodiment, the printed film material is a cast polypropylene (“CPP”) film material, and the second material is a polyvinyl chloride (“PVC”) sheet. The lamination process results in a laminated/multi-layered material that is used to form the toy vehicle shell or body.

Initially, a flattened vehicle body is first printed onto the CPP film, for example through offset printing or roller printing. The printed CPP film is then laminated onto a PVC sheet such that the printed side of the CPP film is trapped and captured between the CPP film and the PVC sheet. By capturing the printed material, which is either a paint-based material or an ink-based material in different embodiments, and other related materials, the issue of migration of any metals or elements in the printed material to the user of the toy is prevented. The laminated CPP and PVC sheet is then die cut into single vehicle body pieces, which are then vacuum-formed and trimmed into a three-dimensional R/C toy vehicle shell or body.

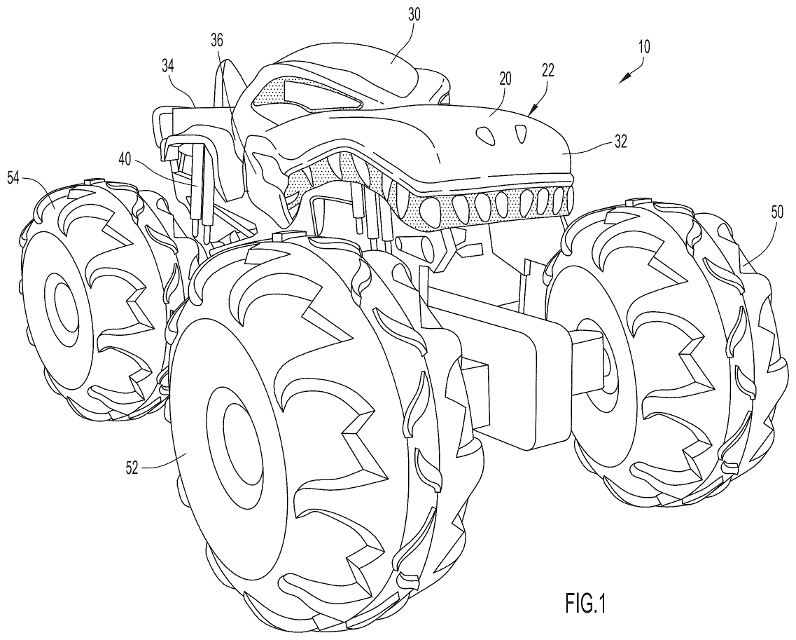

Turning initially to FIG. 1, a front perspective view of a toy vehicle according to the present invention is illustrated. In this embodiment, the toy vehicle 10 includes a vehicle body or shell 20 that is coupled to a frame 40 that has multiple wheels coupled thereto. In FIG. 1, only wheels 50, 52, and 54 are illustrated. In one embodiment, one or more of the wheels of the toy vehicle 10 are driven by an electronic system in the toy vehicle 10. For example, the toy vehicle 10 can be a remotely controlled toy vehicle that includes a drive system with a power source (not shown), such as one or more batteries. In an alternative embodiment, all of the wheels of the toy vehicle 10 may be freely rotatable and not rotated by a drive system.

In one embodiment, the vehicle body or shell 20 is a plastic shell that has a three-dimensional shape as shown in FIG. 1. The vehicle body 20 has an outer surface 22 that may have a textured portion. In addition, the vehicle body 20 may have one or more colors and a visual pattern that may either be a common color or visual pattern or a unique visual pattern for the toy vehicle. The vehicle body 20 includes a central portion 30, a front end 32, a rear end 34, and opposite side portions (noting that only side portion 36 is illustrated in FIG. 1).

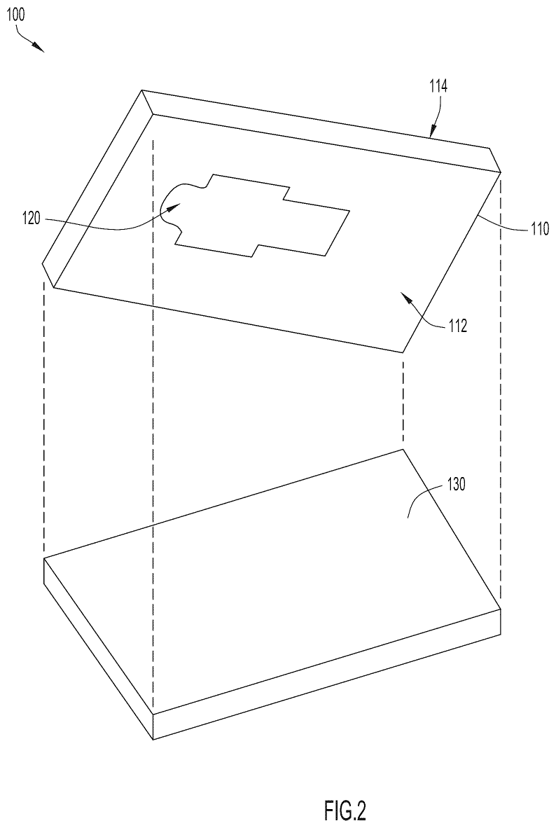

Turning to FIG. 2, an exploded partial perspective view showing different material layers used to form the vehicle body 20 is illustrated. Material layers 100 includes a first material layer 110 that has a first side 112 and a second side 114 that is opposite to the first side 112. As described in greater detail below, a pattern of paint 120 is printed onto the first material layer 110. In particular, the pattern 120 is applied to the first side 112 of the first material layer 110. The material layers 100 also includes a second material layer 130 that is coupled to the first material layer 110, which captures the pattern 120 therebetween. In one embodiment, the first material layer 110 is made of a CPP film material. In one implementation, the CPP film material may have a thickness of 0.03 mm. In addition, the second material layer 130 is made of a PVC material.

It is to be understood that the material layers illustrated in FIG. 2 are only exemplary of portions of material layers that are described in greater detail below. Also, it is to be understood that the orientation of material layer 110 and material layer 130 may be reversed in terms of material layer 130 being located above the material layer 110.

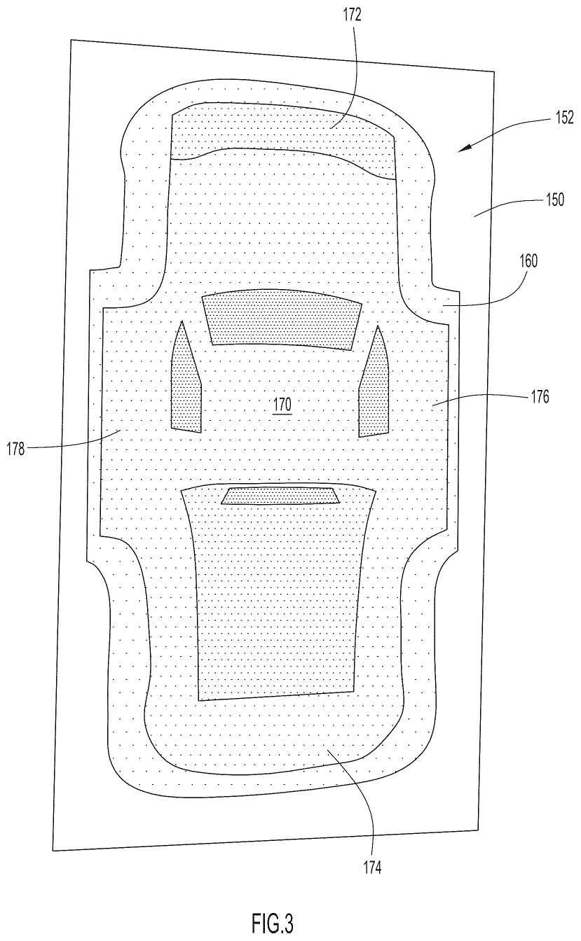

The first step in manufacturing the material layers 100 illustrated in FIG. 2, and thus, a toy vehicle body, is shown in FIG. 3. The first step involves printing a desired material, that will be seen as a toy vehicle body, onto a first material layer.

Referring to FIG. 3, a top view of an embodiment of a pattern or patterned material disposed on a material layer is illustrated. The first material layer 150, which can be a CPP film material, has a first side 152 on which a material 160 is printed. The material 160, which can be referred to as a pattern, a patterned material, or a printed material alternatively, has an appearance that relates to a toy vehicle body, and in particular, is a flattened toy vehicle body.

In this embodiment, the material 160 includes a central portion 170, a front end 172, a rear end 174 opposite the front end 172, and opposite sides 176 and 178. In different embodiments, the size, colors, pattern, and appearance of the printed material 160 can vary, which means that different looking printed materials 160 can be used to form different looking toy vehicle bodies.

The material 160 is applied to the first side 152 using a printing roller. A plurality of layers and rollers may be used in the printing of the material 160 onto the first layer 150, depending on the color, pattern, etc. of the material 160. In certain embodiments, eight to ten layers and/or rollers may be used. In one implementation, there are eight total layers utilized in the roller printing of the material 160 onto first material layer 150. The material 160 can be a paint-based material. The eight layers may include a cyan, magenta, yellow, and black (“CMYK”) color model layer, a Pantone Matching System (“PMS”) layer, and three white layers. In an alternative embodiment, the material 160 can be an ink-based material as well.

While FIG. 3 shows a single printed material 160 on first material layer 150, the first material layer 150 can be a continuous roll of material and the material 160 can be printed at spaced apart intervals along the first material layer 150.

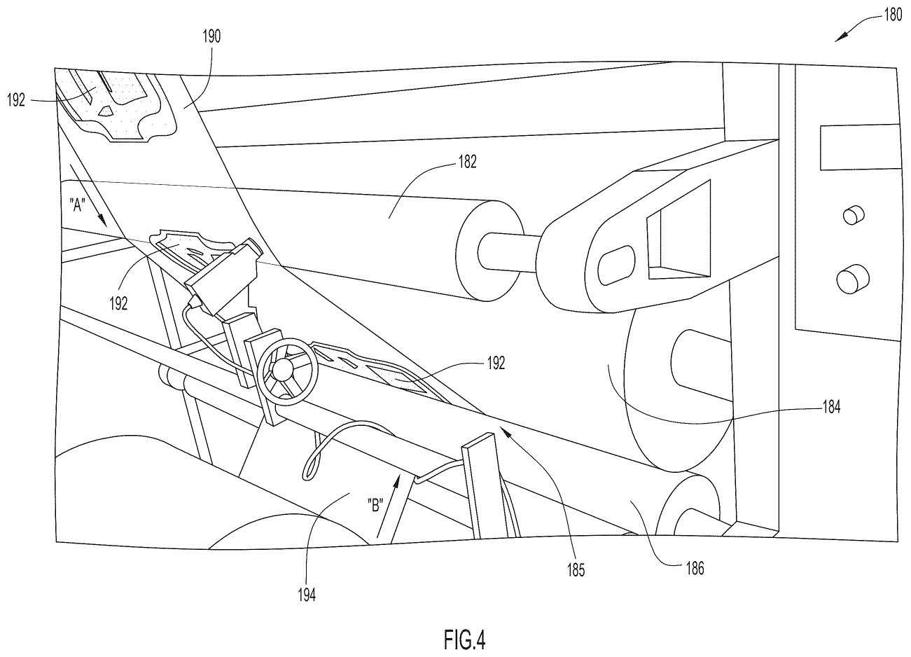

Turning to FIGS. 4-6, the next step in the method of manufacturing a toy vehicle body according to the present invention is illustrated. In this step, a first material, such as a CPP film material, with the printed material 160 is laminated to a second material layer, which can be a PVC material. Referring initially to FIG. 4, a portion of an embodiment of a lamination system 180 is illustrated. Lamination system 180 includes a roller 182 around which a continuous supply of first material layer 190 with spaced apart printed patterns or material 192 travels along the direction of arrow “A”. A continuous supply of second material 194, such as a PVC material, is supplied to the lamination system 180 as well along the direction of arrow “B”. Lamination system 180 includes a pair of rollers 184 and 186 that define a lamination area 185 between which where the first material 190 is laminated to the second material 194.

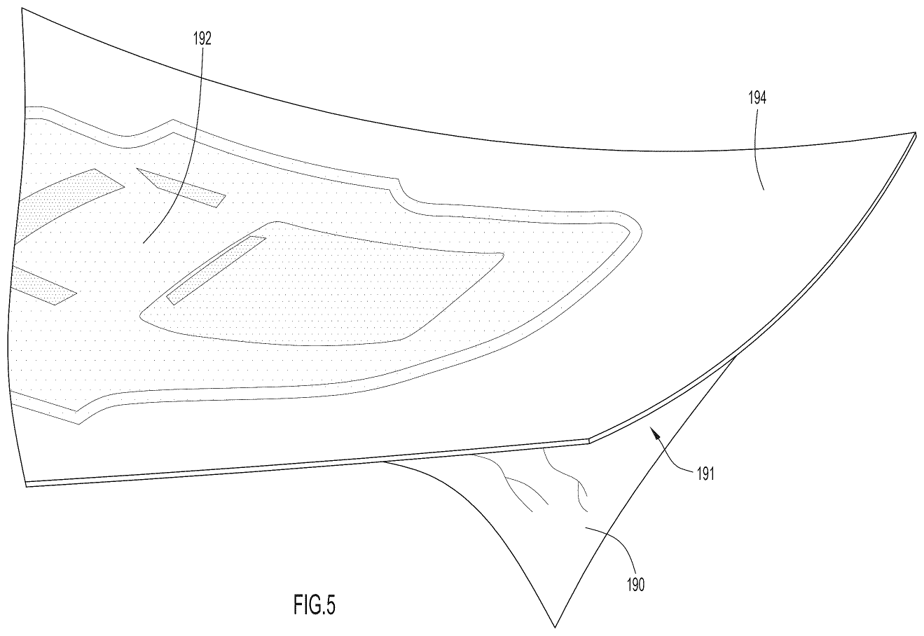

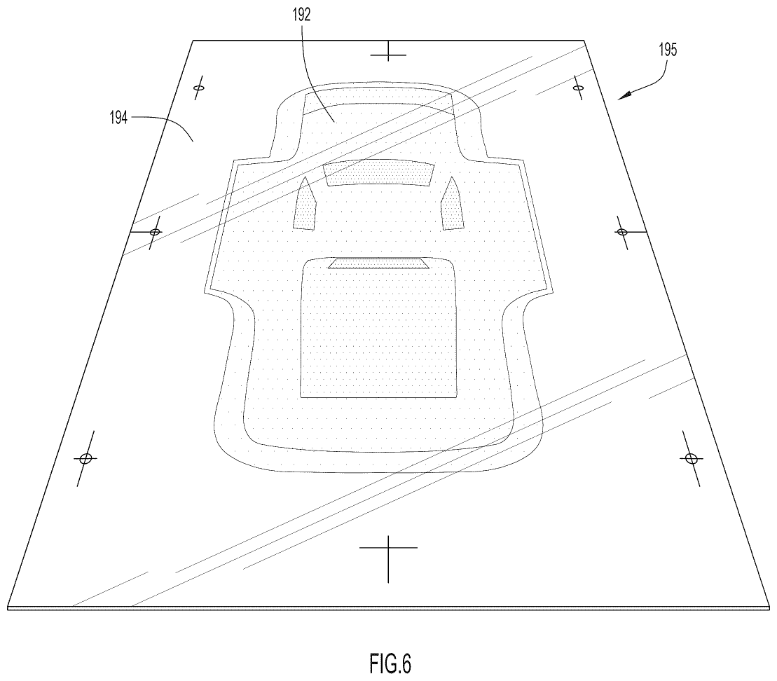

Referring to FIG. 5, the material layers 190 and 194 slightly separated from each other are illustrated. As shown, the printed CPP film material 190 with a first side 191 on which printed pattern 192 is located is shown as being proximate to the second or PVC material 194. In FIG. 6, the laminated product 195 that is formed from material layers 190 and 194 is illustrated. In one embodiment, the laminated product 195 may have a thickness from 0.7 mm to 0.9 mm, depending on the product size. The lamination process results in the printed pattern 192 being located and trapped between the PVC material 194 and the CPP film material 190. When the laminated product 195 is formed into the toy vehicle body as described below, the PVC material 194 is located on the outside of the CPP film material 190. As a result, the toy vehicle body has the PVC material 194 as its outer surface, and the material of printed pattern 192 is not accessible to a child playing with the toy vehicle.

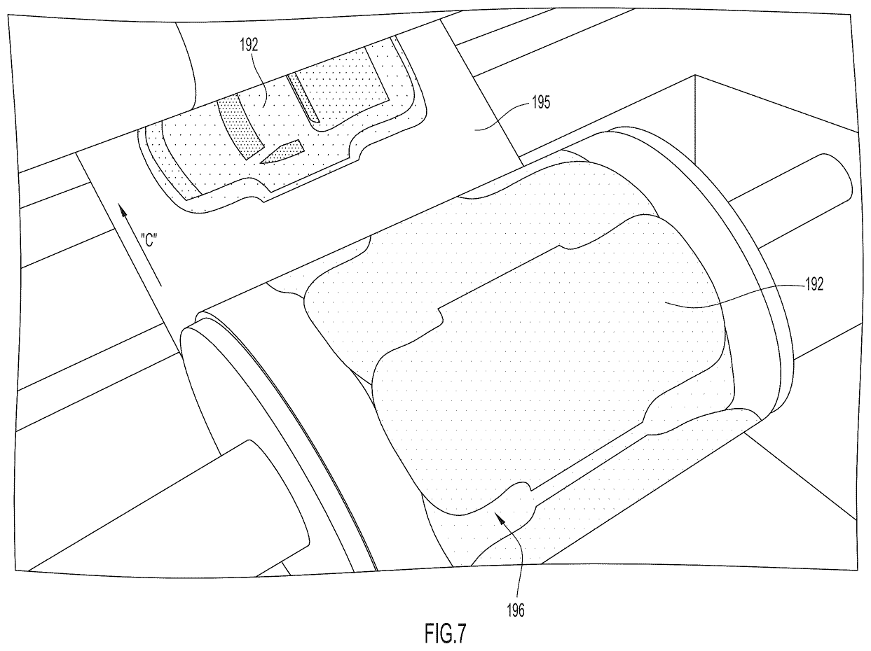

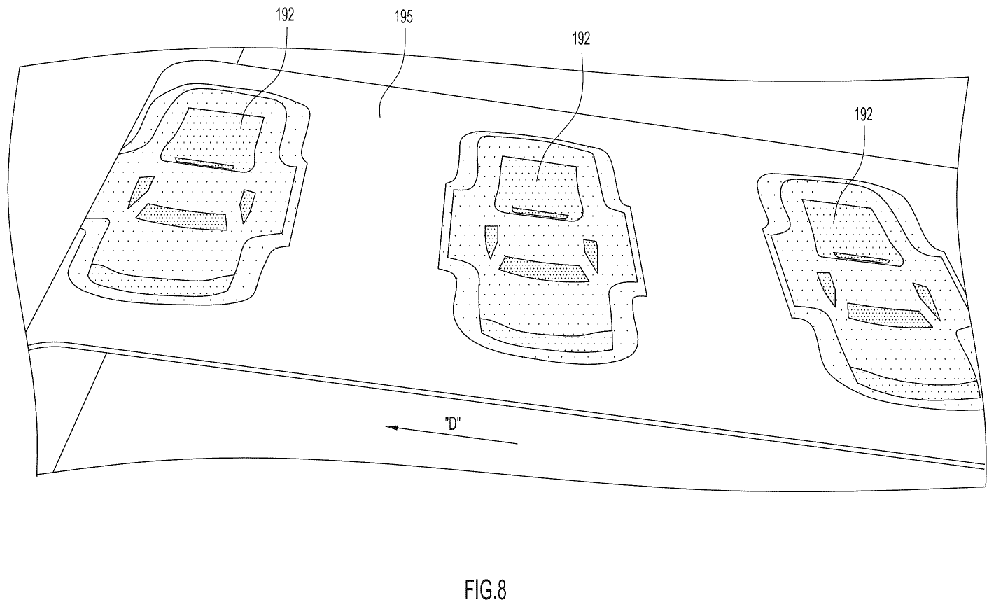

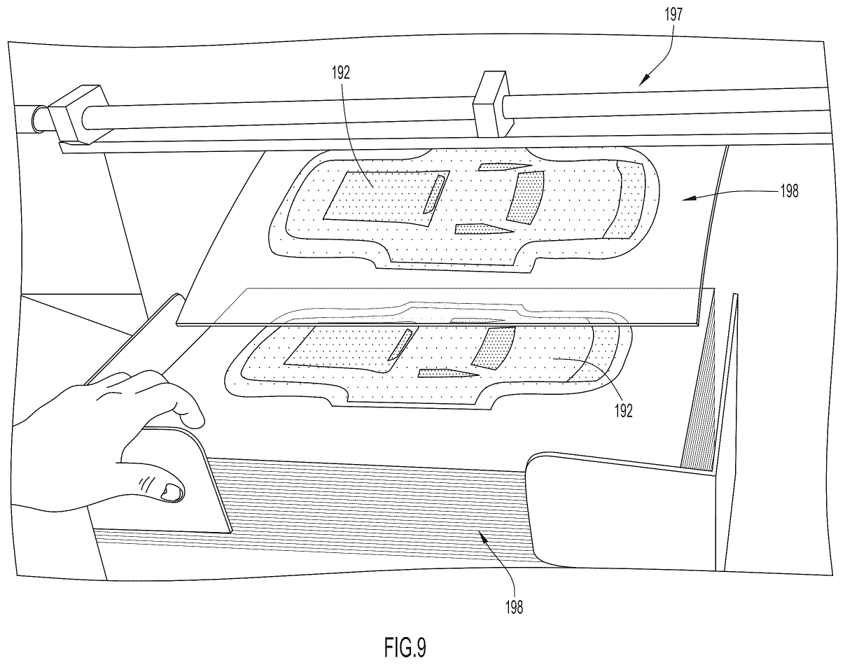

The next step in the method of manufacturing a toy vehicle body according to the present invention is illustrated in FIGS. 7-9. In FIG. 7, the laminated product 195 is collected in the form of a continuous roll 196 that has the printed patterns 192 spaced apart along the roll 196. The laminated product 195 is taken off the continuous roll 196 along the direction of arrow “C” in FIG. 7. The laminated product 195 moves along a series of rollers along the direction of arrow “D” from the continuous roll 196 to a cutting machine. As shown, the printed patterns 192 are spaced apart along the laminated product 195. In FIG. 9, a cutting machine 197, such as a die cut machine, cuts the laminated product 195 from the roll 196 into separate small sheets 198, each of which has a single printed pattern 192 thereon. The single sheets 198 are cut so only one printed pattern 192 remains.

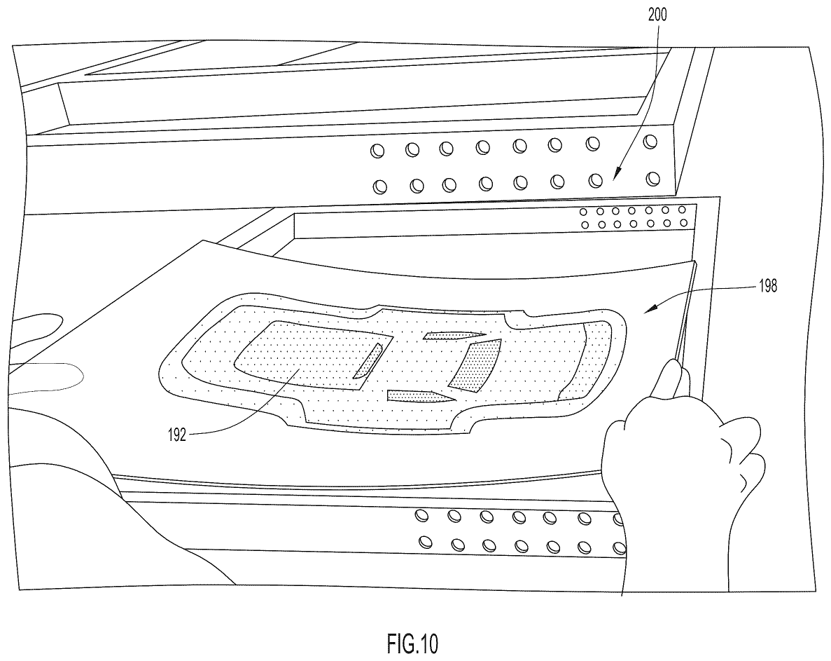

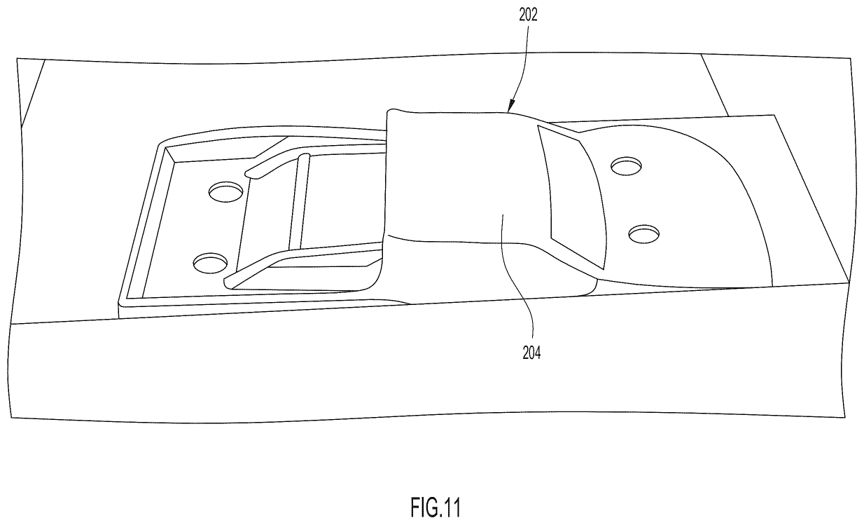

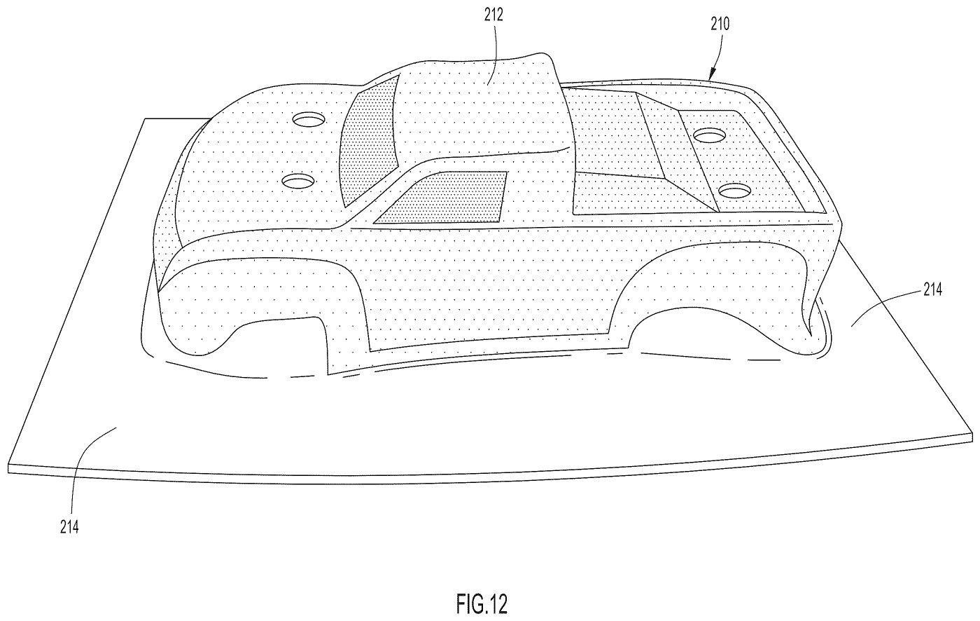

The next step in the method of manufacturing a toy vehicle body according to the present invention is illustrated in FIGS. 10-12. FIG. 10 illustrates a perspective view of a laminated sheet prior to being vacuum formed. The laminated sheet 198 containing printed material 192 therein is placed in a desired orientation in the vacuum forming system 200. The desired orientation is determined by the orientation of the die 202 and its outer surface 204 (see FIG. 11) that are used to mold and form the laminated sheet 198 into a three-dimensional shape 210 (see FIG. 12). After the vacuum forming process, the three-dimensional shape 210 includes the printed material 192 portion formed into a desired toy vehicle body 212 and a perimeter portion 214 surrounding the printed toy vehicle body 212. The perimeter portion 214 primarily includes the first material layer 190 and the second material layer 194 that surround the printed material 192.

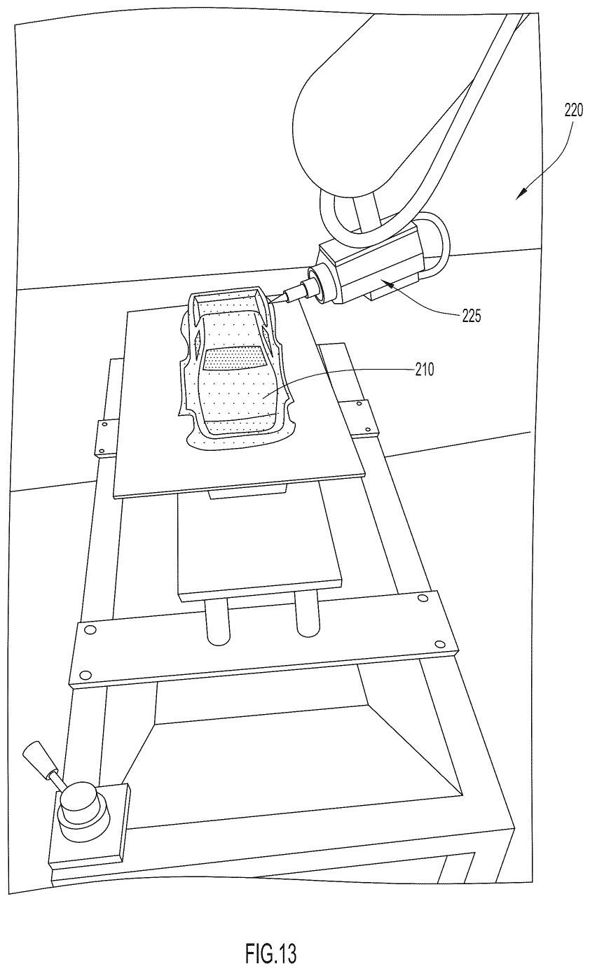

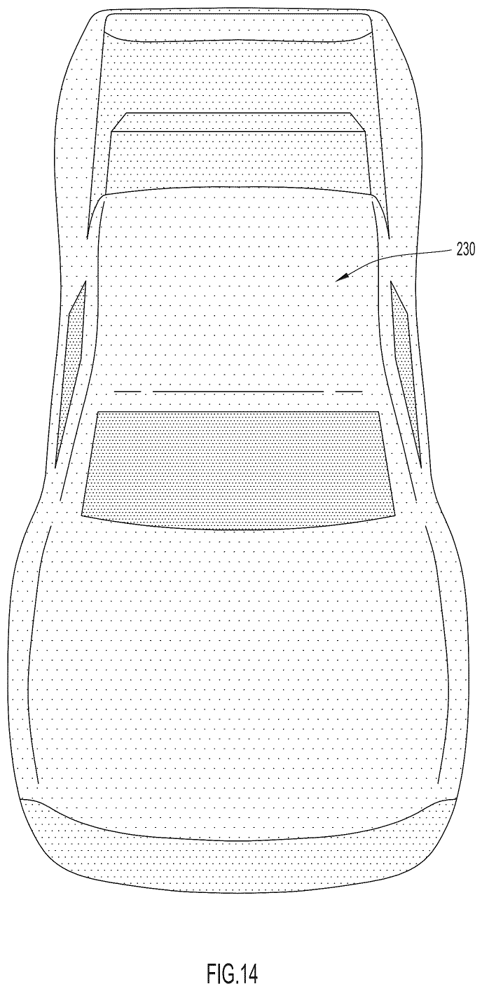

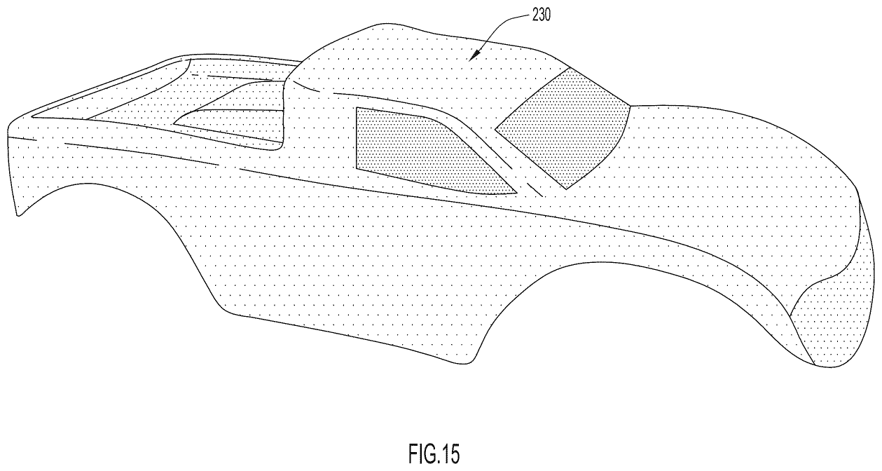

The vacuum formed body 212 is next trimmed to remove the undesired perimeter portion 214. In FIG. 13, a trimming system 220 with a cutter or trimmer 225 is used to separate the desired portion and undesired portion of the toy vehicle body 212. In one embodiment, the trimmer 225 is mounted on a robotic arm that can be manipulated by a control system to cut the desired path along the vacuum formed body 212. The result of the trimming process is the trimmed toy vehicle body 230 illustrated in FIGS. 14 and 15.

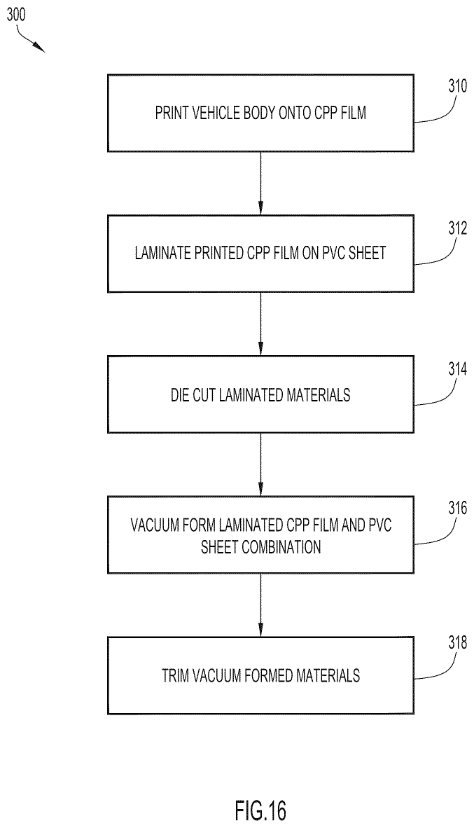

Turning to FIG. 16, an exemplary method of manufacturing a toy vehicle body according to the present invention is illustrated. In this embodiment, the method 300 includes step 310 in which a desired vehicle body pattern is printed onto a CPP film material, which is supplied in a continuous form. Next, in step 312, the printed CPP film material is laminated onto another layer of material, such as a PVC sheet. That laminated material is collected in the form of a continuous roll. In step 314, the continuous roll of laminated material is die cut into single sheets, each of which has a single printed pattern thereon. In step 316, the laminated combination of the CPP film and PVC sheet are vacuum formed into a three-dimensional shape. After the vacuum forming process, the formed shape is trimmed in step 318 to remove any undesirable materials. The result is a three-dimensional toy vehicle body that can be coupled to a toy vehicle frame. The printed material, which is paint, is captured between the CPP film material and the PVC material, and is not engageable by a child playing with the toy vehicle.

While the toy vehicle body presented herein is illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. In addition, various features from one of the embodiments may be incorporated into another of the embodiments. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Accordingly, it is appropriate that the appended claims be construed broadly and in a manner consistent with the scope of the disclosure as set forth in the following claims.

Additionally, it is to be understood that terms such as “first,” “second,” “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Moreover, when used herein, the term “comprises” and its derivations (such as “comprising,” “includes,” “including,” etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. For example, the term “approximately” can denote a tolerance of plus or minus 0.002 inches, 0.001 inches, or up to 0.005 inches, or similarly, the term may denote a tolerance of approximately +/−1.0%. The same applies to the terms “about” and “around” and “substantially.” Moreover, for the purposes of the present disclosure, the phrase “A and/or B” means (A), (B), or (A and B), and the phrase “A, B, and/or C” means (A), (B), (C), (A and B), (A and C), (B and C), or (A, B and C).

What is claimed is:

1. A toy vehicle, comprising:
a frame having a plurality of wheels coupled thereto; and
a body coupled to the frame, wherein the body includes a first layer of material on which another material is printed and a second layer of material, the second layer of material being coupled to the first layer of material, and the body is shaped into a three-dimensional shape.

2. The toy vehicle of claim 1, wherein the body is shaped into the three-dimensional shape by vacuum forming.

3. The toy vehicle of claim 1, wherein the second layer of material is laminated to the first layer of material.

4. The toy vehicle of claim 3, wherein the second layer of material is polyvinyl chloride.

5. The toy vehicle of claim 4, wherein the first layer of material is a cast polypropylene film.

6. The toy vehicle of claim 1, wherein the first layer of material has a first side and a second side opposite the first side, and the material printed on the first layer of material is printed on the first side of the first layer of material.

7. The toy vehicle of claim 6, wherein the second layer of material is coupled to the first side of the first layer of material so that the material printed on the first side of the first layer of material is located between the first layer of material and the second layer of material.

8. The toy vehicle of claim 7, wherein the second layer of material is laminated to the first layer of material.

9. A shell for a body of a toy vehicle, the shell comprising:
a first layer of material;
a second layer of material; and
a patterned material, wherein the patterned material is disposed on the first layer of material, the second layer of material is coupled to the first layer of material, and the first layer of material and the second layer of material are formed into a three-dimensional shape.

10. The shell of claim 9, wherein the first layer of material and the second layer of material are formed into a three-dimensional shape by vacuum forming.

11. The shell of claim 9, wherein the patterned material is printed onto the first layer of material.

12. The shell of claim 10, wherein the patterned material is located between the first layer of material and the second layer of material when the second layer of material is coupled to the first layer of material.

13. The shell of claim 12, wherein the second layer of material is laminated to the first layer of material.

14. The shell of claim 13, wherein the first layer of material is a cast polypropylene film and the second layer of material is polyvinyl chloride.

15. The shell of claim 14, wherein the first layer of material has a first side and a second side opposite the first side, and the patterned material is printed on the first side of the first layer of material.

16. The shell of claim 15, wherein the second layer of material is coupled to the first side of the first layer of material so that the patterned material is located between the first layer of material and the second layer of material.

17. A method of manufacturing a body of a toy vehicle, comprising the steps of:
printing a pattern onto a first material;
laminating a second material to the first material, the pattern being located between the second material and the first material; and
forming the laminated first material and second material into a three-dimensional shape for use as the body of the toy vehicle.

18. The method of manufacturing of claim 17, wherein the first material is a cast polypropylene material, and the second material is a polyvinyl chloride material.

19. The method of manufacturing of claim 17, further comprising the step of:
cutting the laminated first material and second material into single pieces prior to the step of forming the laminated first material and second material into a three-dimensional shape.

20. The method of manufacturing of claim 19, further comprising the step of:
trimming the three-dimensional shape after the step of forming the laminated first material and second material into a three-dimensional shape.
